(19) United States
(12) Patent Application Publication
(10) Pub. No.: US 2011/0143623 A1
(43) Pub. Date: Jun. 16, 2011

(54) STRETCHED ELASTIC NONWOVENS

(75) Inventors: Jean Claude Abed, Simpsonville, SC (US); Henning Roettger, Kaltenkirchen (DE); Steven P. Webb, Maple Grove, MN (US); Jared A. Austin, Greer, SC (US)

(73) Assignee: ADVANCED DESIGN CONCEPT GMBH, Hanover (DE)

(21) Appl. No.: 11/659,298

(22) PCT Filed: Aug. 3, 2005
(86) PCT No.: PCT/US05/27775

§ 371 Date: Feb. 9, 2009

Related U.S. Application Data
(60) Provisional application No. 60/598,322, filed on Aug. 3, 2004.

(51) Int. Cl. D04H 13/00; B29C 55/10

(52) U.S. Cl. 442/329; 264/290.2; 264/113

(57) ABSTRACT

A method for producing an elastic nonwoven fabric, comprising: stretching a nonwoven web in the cross machine direction, machine direction, or both directions to reduce the basis weight and/or denier of the nonwoven web to form the elastic nonwoven fabric, wherein the nonwoven web comprises a plurality of multicomponent strands having first and second polymer components longitudinally coextensive along the length of the strands, said first component comprising an elastomeric polymer, and said second polymer component comprising a polymer less elastic than the first polymer component.

This application claims priority to U.S. provisional patent application Ser. No. 60/598,322, filed Aug. 3, 2004, and incorporated herein by reference.

### FIELD OF THE INVENTION

The invention relates to nonwoven fabrics produced from multi-component strands, processes for producing nonwoven webs, and products using the nonwoven webs. The nonwoven webs of the invention can be produced from multi-component strands including at least two components, a first, elastic polymeric component and a second, extensible but less elastic polymeric component.

### BACKGROUND OF THE INVENTION

In recent years there has been a dramatic growth in the use of nonwovens, particularly elastomeric nonwovens, in disposable hygiene products. For example, elastic nonwoven fabrics have been incorporated into bandaging materials, garments, diapers, support clothing, and feminine hygiene products. The incorporation of elastomeric components into these products provides improved fit, comfort and leakage control.

However, the inventors have determined that certain methods of achieving low basis weights of nonwovens made using elastic fibers, such as bicomponent fibers, have been unsatisfactory because of the resistance to draw and the fibers reverting back to their original lengths/widths. As a result it is difficult to achieve small fiber diameters in a final fabric. Elastic nonwovens may have undesirably high fiber diameter and/or denier, resulting in fabrics at low basis weights having poor uniformity and poor general coverage.

The present inventors have recognized that a solution to one or more of these problems impacting elastic nonwovens would be highly desirable, especially if the elastic properties of these nonwovens were not compromised.

### SUMMARY OF THE INVENTION

The present invention employs elastic nonwoven webs made from a plurality of strands comprising at least two polymeric components where one component is elastic and another component is less elastic but extensible wherein the bonded nonwoven web has been subjected to biaxial stretching and thus can overcome a variety of problems in the field. The elastic nonwoven webs are directly stretched, (biaxially, in the cross machine direction, or in the machine direction) optionally with heating to decrease the basis weight of the nonwoven web. Such direct stretching does not encompass incremental stretching and other non-direct stretching methods. It has been discovered that the use of a tenter frame, for example, to stretch the web in the cross machine direction (CD) while simultaneously or sequentially stretching the web in the machine direction (MD) using differential speeds produces a unexpectedly and substantial lowering of the basis weight relative to stretching by other methods. It should be noted that cross direction generally refers to the width of a fabric in a direction generally perpendicular to the direction in which it is produced, as opposed to machine direction which refers to the length of a fabric in the direction in which it is produced. It has also been found that this reduction of basis weight can be achieved by stretching in the cross direction or machine direction. If stretching is performed in the machine direction, the width must be kept at a fixed width to achieve the basis weight reduction. In addition, it has been found, surprisingly, that in the practice of this invention, stretching of a lower percentage is needed to achieve the same basis weight reduction as using other methods. For example, in one instance 375% elongation was needed using incremental stretching to achieve a given basis weight reduction, but 150% or less elongation was needed to achieve this elongation using a direct stretch (biaxial, CD, or MD). Similarly, using the process of this invention, a 200% biaxial stretch at room temperature led to a 30% decrease in basis weight in contrast to a 400% stretch using ring rollers (incremental stretching) at room temperature led to only a 10% decrease in basis weight. Even if the basis weight is not reduced significantly (e.g., less than or equal to 10% reduction), it has been found additionally that the use of direct stretching, under the conditions set forth in this invention, can change elastic properties (increased extensional force, decreased set, decreased stress relaxation, and increased retractive force) as well as achieving a MD/CD or CD/MD (where ratio of the direction of stretch divided by direction not stretched) ratio parameter that has a larger value after stretching, which is desirable depending on the end use. For example, it was found that an incremental stretch at 387% elongation gave a 50% to 100% increase in the ratio after 1 and 2 passes with MD activation, while it gives a little over 100% increase in CD ratio after CD activation, regardless of the number of passes. In the practice of this invention, approximately a 100% increase in the ratio was a achieved with 125% elongation in the MD only (see Example 15) and with 105% and 138% elongation in the CD only (see Examples 10 and 11). CD and MD stretching both generally achieve softening, the extensional forces typically go down, and the retractive forces typically go down.

The present invention is generally directed to methods for producing elastic nonwoven webs and fabrics that may include melt spinning a plurality of multicomponent strands having first and second polymer components longitudinally coextensive along the length of the filament. The first component is formed from an elastomeric polymer and the second component is formed from a less elastomeric polymer. The melt spun strands are formed into a nonwoven web which is subsequently bonded and stretched to reduce the basis weight and denier of the nonwoven without diminishing the elastic and physical properties of the nonwoven materials beyond acceptable ranges. This is achieved by post mechanically stretching a pre-made thermopoint bonded elastic nonwoven in either machine, transverse, or preferably both directions. The nonwoven can be preheated prior to or during the stretching, or not heated.

With respect to the multicomponent strands, the first and second components can be derived from any of a wide variety of polymers. In one embodiment of the invention, the first polymer component is formed from an elastomeric polyurethane, elastomeric styrene block copolymer, or an elastomeric polyolefin and the second polymer component is formed from a polyolefin that is less elastic than the first component.

The present invention further includes elastic nonwoven fabrics produced by the methods of the invention, as well as the multicomponent elastic fibers made after stretching.

In one broad respect, this invention is a method for producing an elastic nonwoven fabric, comprising: stretching a nonwoven web in at least one direction, such as by CD stretching, MD stretching, or both directions either simultaneously or sequentially at an elevated temperature to reduce the basis weight and/or denier of the web, wherein the nonwoven web comprises a plurality of multicomponent strands having first and second polymer components longitudinally coextensive along the length of the strands, said first component comprising an elastomeric polymer, and said second polymer component comprising a polymer less elastic than the first polymer component. Thus in one broad respect, this invention is a method for producing an elastic nonwoven fabric, comprising: stretching a nonwoven web in the cross machine direction, machine direction, or both to reduce the basis weight, denier, or both of the nonwoven web to form the elastic nonwoven fabric, wherein the nonwoven web comprises a plurality of multicomponent strands having first and second polymer components longitudinally coextensive along the length of the strands, said first component comprising an elastomeric polymer, and said second polymer component comprising a polymer less elastic than the first polymer component

In one embodiment, the nonwoven web can be formed by: melt spinning a plurality of multicomponent strands having first and second polymer components longitudinally coextensive along the length of the strands, said first component comprising an elastomeric polymer, and said second polymer component comprising a non-elastomeric polymer; forming the multicomponent strands into a nonwoven web; and multipoint bonding the strands to form a coherent bonded nonwoven web; and stretching the bonded nonwoven in at least one direction.

In another broad respect, this invention is a stretched, thermopoint bonded nonwoven web, made from the multicomponent strands.

In another broad respect, this invention is a garment comprising a plurality of layers, wherein at least one of said layers comprises the nonwoven fabric described above.

The fibers, articles, or garments of the present invention have utility in a variety of applications. Suitable applications include, for example, but are not limited to, disposable personal hygiene products (e.g. training pants, diapers, absorbent underpants, incontinence products, feminine hygiene items and the like); disposable garments (e.g. industrial apparel, coveralls, head coverings, underpants, pants, shirts, gloves, socks and the like); infection control/clean room products (e.g. surgical gowns and drapes, face masks, head coverings, surgical caps and hood, shoe coverings, boot slippers, wound dressings, bandages, sterilization wraps, wipers, lab coats, coverall, pants, aprons, jackets), and durable and semi-durable applications such as bedding items and sheets, furniture dust covers, apparel interliners, car covers, and sports or general wear apparel.

### DETAILED DESCRIPTION OF THE INVENTION

Nonwovens are commonly made by melt spinning thermoplastic materials. Such nonwovens are called “spunbond” or “meltblown” materials and methods for making these polymeric materials are also well known in the field. Spunbonded materials are preferred in this invention due to advantageous economics. While spunbond materials with desirable combinations of physical properties, especially combinations of softness, strength and durability, have been produced, significant problems have been encountered. The nonwovens employed in this invention are typically conjugate fibers and typically bicomponent fibers. In one embodiment the nonwoven is made from bicomponent fibers having a sheath/core structure. Representative bicomponent, elastic nonwovens and the process for making them, suitable for this invention, are given by Austin in WO 00/08243, incorporated herein by reference in its entirety.

Elastic nonwoven fabrics can be employed in a variety of environments such as bandaging materials, garments such as work wear and medical gowns, diapers, support clothing, incontinence products, diapers, training pants, and other personal hygiene products because of their breathability as well as their ability to allow more freedom of body movement than fabrics with more limited elasticity. Of particular relevance to this invention are articles that form diaper backsheets, protective apparel, medical gowns, and drapes.

As used herein, the term “strand” is being used as a term generic to both “fiber” and filament”. In this regard, “filaments” are referring to continuous strands of material while “fibers” mean cut or discontinuous strands having a definite length. Thus, while the following discussion may use “strand” or “fiber” or “filament”, the discussion can be equally applied to all three terms.

Specifically, what is about to be described hereinbelow for the elastic nonwoven are what we would define as “chemically” elastic fibers. To those skilled in the art it will be readily apparent the distinction of these fibers from the less elastic, 1-dimensionally elastic, “physical” or “mechanical” elastic nonwovens produced via heat stretching of an otherwise essentially inelastic nonwoven.

Briefly, the bicomponent strands used to make the elastic nonwoven are typically composed of a first component and a second component. The first component is an “elastic” polymer(s) which refers to a polymer that, when subjected to an extension, deforms or stretches within its elastic limit (i.e., it retracts when released). Many fiber forming thermoplastic elastomers are known in the art and include polyurethanes, block copolyesters, block copolyamides, styrenic block polymers, and polyolefin elastomers including polyolefin copolymers. Representative examples of commercially available elastomers for the first (inner) component include the KRATON polymers sold formerly by Kraton Corp.; ENGAGE elastomers (sold by Dupont Dow Elastomers), VERSIFY elastomers (produced by Dow Chemical) or, VISTAMAXX (produced by Exxon-Mobile Corp.) polyolefin elastomers; and the VECTOR polymers sold by DEXCO. Other elastomeric thermoplastic polymers include polyurethane elastomeric materials (“TPU”), such as PELLETHANE sold by Dow Chemical, ELASTOLLAN sold by BASF, ESTANE sold by B.F. Goodrich Company; polyester elastomers such as HYTREL sold by E.I. Du Pont De Nemours Company; polyetherester elastomeric materials, such as ARNITEL sold by Akzo Plastics; and polyetheramide materials, such as PEBAX sold by Elf Atochem Company. Heterophasic block copolymers, such as those sold by Montel under the trade name CATALLOY are also advantageously employed in the invention. Also suitable for the invention are polypropylene polymers and copolymers described in U.S. Pat. No. 5,594,080.

The second component is also a polymer(s), preferably a polymer which is extensible. Any thermoplastic, fiber forming, polymer would be possible as the second component, depending on the application. Cost, stiffness, melt strength, spin rate, stability, etc will all be a consideration. The second component may be formed from any polymer or polymer composition exhibiting inferior elastic properties in comparison to the polymer or polymer composition used to form the first component. Exemplary non-elastomeric, fiber-forming thermoplastic polymers include polyolefins, e.g. polyethylene (including LLDPE), polypropylene, and polybutene, polyester, polyamide, polystyrene, and blends thereof. The second component polymer may have elastic recovery and may stretch within its elastic limit as the bicomponent strand is stretched. However, this second component is selected to provide poorer elastic recovery than the first component polymer. The second component may also be a polymer which can be stretched beyond its elastic limit and permanently elongated by the application of tensile stress. For example, when an elongated bicomponent filament having the second component at the surface thereof contracts, the second component will typically assume a compacted form, providing the surface of the filament with a rough appearance.

In order to have the best elastic properties, it is advantageous to have the elastic first component occupy the largest part of the filament cross section. In one embodiment, when the strands are employed in a bonded web environment, the bonded web has a root mean square average recoverable elongation of at least about 65% based on machine direction and cross direction recoverable elongation values after 50% elongation and one pull. The root mean square average recoverable elongation is the square root of the sum of (percent recovery in the machine direction)²+percent recovery in the cross machine direction)².

The second component is typically present in an amount less than about 50 percent by weight of the strand, with between about 1 and about 20 percent in one embodiment and about 5-10 percent in another embodiment, depending on the exact polymer(s) employed as the second component.

In one respect, where the second component is substantially not elastic resulting in the strand being not elastic as a whole, in one embodiment the second component is present in an amount such that the strand becomes elastic upon stretching of the strand by an amount sufficient to irreversibly alter the length of the second component.

Suitable materials for use as the first and second components are selected based on the desired function for the strand. Preferably, the polymers used in the components of the invention have melt flows from about 5 to about 1000. Generally, the meltblowing process will employ polymers of a higher melt flow than the spunbonded process.

These bicomponent strands can be made with or without the use of processing additives. In the practice of this invention, blends of two or more polymers can be used for either the first component or second component or both.

The first (the elastic component of the present invention) and second components may be present within the multicomponent strands in any suitable amounts, depending on the specific shape of the fiber and end use properties desired. In advantageous embodiments, the first component forms the majority of the fiber, i.e., greater than about 50 percent by weight, based on the weight of the strand (“bos”). For example, the first component may beneficially be present in the multicomponent strand in an amount ranging from about 80 to 99 weight percent bos, such as in an amount ranging from about 85 to 95 weight percent bos. In such advantageous embodiments, the non-elastomeric component would be present in an amount less than about 50 weight percent bos, such as in an amount of between about 1 and about 20 weight percent bos. In beneficial aspects of such advantageous embodiments, the second component may be present in an amount ranging from about 5 to 15 weight percent bos, depending on the exact polymer(s) employed as the second component. In one advantageous embodiment, a sheath/core configuration having a core to sheath weight ratio of greater than or equal to about 85:15 is provided, such as a ratio of 95:5.

The shape of the fiber can vary widely. For example, typical fiber has a circular cross-sectional shape, but sometimes fibers have different shapes, such as a trilobal shape, or a flat (i.e., “ribbon” like) shape. Also the fibers, even though of circular cross-section, may assume a non-cylindrical, 3-dimensional shape, especially when stretched and released (self-bulking or self-crimping to form helical or spring-like fibers).

For the inventive elastic fibers disclosed herein, the diameter can be widely varied. The fiber denier can be adjusted to suit the capabilities of the finished article. Expected fiber diameter values would be: from about 5 to about 20 microns/filament for melt blown; from about 10 to about 50 micron/filament for spunbond; and from about 20 to about 200 micron/filament for continuous wound filament.

Basis weight refers to the area density of a non-woven fabric, usually in terms of g/m² or oz/yd². Acceptable basis weight for a nonwoven fabric is determined by application in a product. Generally, one chooses the lowest basis weight (lowest cost) that meets the properties dictated by a given product. For elastomeric nonwovens one issue is retractive force at some elongation, or how much force the fabric can apply after relaxation at a certain extension. Another issue defining basis weight is coverage, where it is usually desirable to have a relatively opaque fabric, or if translucent, the apparent holes in the fabric should be of small size and homogeneous distribution. The most useful basis weights in the nonwovens industry for disposable products range from ½ to 4.5 oz/yd² (17 to 150 g/m², or gsm). Some applications, such as durable or semi-durable products, may be able to tolerate even higher basis weights. It should be understood that high or low basis weight materials may be adventitiously produced in a multiple beam construction. That is, it may be useful to produce an SMS (spunbond/meltblown/spunbond) composite fabric where each of the individual layers have basis weights even less than 17 gsm, but it is expected that the preferred final basis weight will be at least 17 gsm.

A nonwoven composition or article is typically a web or fabric having a structure of individual fibers or threads which are randomly interlaid, but not in an identifiable manner as is the case for a woven or knitted fabric.

The first and second polymeric components can optionally include, without limitation, pigments, antioxidants, stabilizers, surfactants, waxes, flow promoters, solid solvents, particulates and material added to enhance processability of the composition.

It should be appreciated that an elastic material or elastic-like nonwoven, as applicable to this invention, typically refers to any material having a root mean square average recoverable elongation of about 65% or more based on machine direction and cross-direction recoverable elongation values after 50% elongation of the web and one pull. The extent that a material does not return to its original dimensions after being stretched and immediately released is its percent permanent set. According to ASTM testing methods, set and recovery will add to 100%. Set is defined as the residual relaxed length after an extension divided by the length of extension (elongation). For example, a one inch gauge (length) sample, pulled to 200% elongation (two additional inches of extension from the original one inch gauge) and released might a) not retract at all so that the sample is now three inches long and will have 100% set ((3″_{end}−1″ᵢₙᵢₜᵢₐₗ)/2″ₑₓₜₑₙₛᵢₒₙ), or b) retract completely to the original one inch gauge and will have 0% set ((1″_{end}−1″ᵢₙᵢₜᵢₐₗ)/2″ₑₓₜₑₙₜᵢₒₙ), or c) will do something in between. An often used and practical method of measuring set is to observe the residual strain (recovery) on a sample when the restoring force or load reaches zero after it is released from an extension. This method and the above method will only produce the same result when a sample is extended 100%. For example, as in the case above, if the sample did not retract at all after 200% elongation, the residual strain at zero load upon release would be 200%. Clearly in this case set and recovery will not add to 100%.

By contrast, a non-elastic nonwoven does not meet these criteria. Specifically, a non-elastic nonwoven would be expected to demonstrate less than 50%, more likely less than 25%, recovery when extended to 50% of its original length. Moreover, non-elastic nonwovens are typically described by a tensile curve that shows extensive yielding prior to break. In this regard the nonwoven will show a rapid increase in stress at small extensions followed by a near maximum, approximately constant stress at the yield point and during continued extension until the nonwoven ruptures. Prior to rupture a release of the sample results in an extensively elongated, non-fully-retracted nonwoven.

Nonwoven webs can be produced from the multicomponent strands of the invention by any technique known in the art. A class of processes, known as spunbonding is one common method for forming nonwoven webs. Examples of the various types of spunbonded processes are described in U.S. Pat. No. 3,338,992 to Kinney, U.S. Pat. No. 3,692,613 to Dorschner, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al. In general, traditional spunbonded processes include:

a) extruding the strands from a spinneret;

b) quenching the strands with a flow of air which is generally cooled in order to hasten the solidification of the molten strands;

c) attenuating the filaments by advancing them through the quench zone with a draw tension that can be applied by either pneumatically entraining the filaments in an air stream or by wrapping them around mechanical draw rolls of the type commonly used in the textile fibers industry;

d) collecting the drawn strands into a web on a foraminous surface; and

e) bonding the web of loose strands into a fabric.

This bonding can use any thermal, chemical or mechanical bonding treatment known in the art to impart coherent web structures. Thermal point bonding may advantageously be employed in the practice of this invention. Various thermal point bonding techniques are known, with the most preferred utilizing calender rolls with a point bonding pattern. Any pattern known in the art may be used with typical embodiments employing continuous or discontinuous patterns. Preferably, the bonds cover between 6 and 30 percent, and most preferably, 16 percent of the layer is covered. By bonding the web in accordance with these percentage ranges, the filaments are allowed to elongate throughout the full extent of stretching while the strength and integrity of the fabric can be maintained. In alternative aspects of the invention, bonding processes that entangle or intertwine the strands within the web may be employed. An exemplary bonding process which relies upon entanglement or intertwining is hydroentanglement.

All of the spunbonded processes of this type can be used to make the elastic fabric of this invention if they are outfitted with a spinneret and extrusion system capable of producing multicomponent strands. However, one preferred method involves providing improved web laydown via a vacuum located under the forming surface. This method provides for a continually increasing strand velocity to the forming surface, and so provides little opportunity for the elastic strands to snap back.

Another class of process, known as meltblowing, can also be used to produce the nonwoven fabrics of this invention. This approach to web formation is described in NRL Report 4364 “Manufacture of Superfine Organic Fibers” by V. A. Wendt, E. L. Boone, and C. D. Fluharty and in U.S. Pat. No. 3,849,241 to Buntin et al. Conventional meltblowing process generally involve:

a.) Extruding the strands from a spinneret.

b.) Simultaneously quenching and attenuating the polymer stream immediately below the spinneret using streams of high velocity heated air. Generally, the strands are drawn to very small diameters by this means. However, by reducing the air volume and velocity, it is possible to produce strand with deniers similar to common textile fibers.

c.) Collecting the drawn strands into a web on a foraminous surface. Meltblown webs can be bonded by a variety of means, but often the entanglement of the filaments in the web or the autogeneous bonding in the case of elastomers provides sufficient tensile strength so that it can be wound onto a roll. Thermopoint bonding is advantageously used in the practice of this invention.

Any meltblowing process which provides for the extrusion of multicomponent strands such as that set forth in U.S. Pat. No. 5,290,626 can be used to practice this invention.

The fabric of the invention may also be treated with other treatments such as antistatic agents, alcohol repellents and the like, by techniques that would be recognized by those skilled in the art.

After bonding the nonwoven web, the material is biaxially stretched, optionally under elevated temperature, to affect the basis weight reduction. Typically the stretching is accomplished by use of tenter frame stretching in the cross direction in combination with or subsequent to differential speed stretching in the machine direction. For example, a thermopoint bonded elastic nonwoven web is fed by a suitable conveyor to fabric stretching means in the form of a conventional tenter apparatus or frame. At a first position, two endless chains respectively engage the edge portions of the web with a series of hooks or clamps mounted and simultaneously convey the thus engaged fabric to a second position and stretch the fabric web transversely relative to its direction of travel. During the stretching the web may also heated to a temperature of about 20 C (room temperature), in one embodiment to about 40 C, and in another embodiment to about 60 C. Optimal heating temperature selection is a complicated function of, amongst others, the speed of the fabric, the construction of the fibers, the materials used, and the final properties (basis weight and elastomeric) desired. Generally the temperature of the web (the external temperature may be higher than this) will be less than or about equal to a temperature that could be used to thermopoint bond the web. Any available form of tenter frame may be used in the practice of the present invention. The tenter frame selected should, however, be one which provides even air flow across the web. The tenter frame should also be equipped with overfeed means to allow as much as 30% overfeed, so that the fabric can be relaxed during processing to permit controlled shrinkage. Tenter frames may be composed of successive chambers or zones, provided with separate means for circulating hot air therethrough and it may be desirable in certain circumstances involving the practice of the invention to vary the temperature of the circulating air. In general, the web is stretched at least 50% during this step. In one embodiment, the web is stretched using the tenter frame at least 100%.

Previously, subsequently, or simultaneously to transverse stretching, the web is typically stretched using differential speeds of the rollers in the machine direction. In this regard, “biaxial” stretching refers to stretching ultimately in both the CD and MD. For example, where there is a 2×difference in speed between the feed and take up rollers, a 100% stretch of the web occurs in the machine direction. Other stretch percentages may be employed in the practice of this invention. It should be appreciated that the web may also be subjected to heating during the machine direction stretch, at temperatures generally the same as the temperature during cross direction stretching.

It should be appreciated that the stretching can occur in a single step, or can be performed by multiple stretches to affect the desired stretch and basis weight. For example, the nonwoven can be subjected to a 100% stretch followed by a 50% stretch, instead of a single 200% stretch (to achieve a 3× overall stretch).

The basis weight of the nonwoven web is reduced at least 10% subsequent to biaxial stretching. In one embodiment, the basis weight is reduced at least 20%. In another embodiment, the basis weight is reduced about 30% or even higher.

The present invention will be further illustrated by the following non-limiting examples. The foregoing examples are illustrative of the present invention and are not to be construed as limiting the scope of the invention or claims appended hereto.

Determinations of the properties for the Examples below were made in the following manner. Basis weight was measured by either the actual samples that were tested or multiple 10×10 cm pieces were cut and weighed and normalized to their known area. Fiber diameter was determined by microscopic investigation over random areas of a sample and were data was obtained and averaged. Tensile tests was determined using a tensile testing device to measure stress vs. strain for the exemplary nonwoven spunlaid fabrics as detailed below. Samples were separately cut from their webs in either the MD or CD directions as noted in the Tables. All values presented in the Tables have been normalized to an equivalent 50 gsm fabric of 3.0″ width.

Tensile Testing

A tensile testing device (Instron or Zwick) was used to determine: extensional forces, retractive forces, set and stress relaxation. A 2+-cycle stress/strain program was used. Each cycle extended the sample to 100% and then returned immediately to 0% at a rate of 500%/min. There was no wait between the cycles or before evaluations. Extensional force at 100% elongation was determined from the force measured at the end of the extension of the second cycle. Retractive forces (either at 50 or 30%) were determined by recording the force during the retraction of the sample during the second cycle. Set was measured from the value for the % elongation of the sample at 0 load during the retraction step of the second cycle. Set was directly determined from this elongation as described above. Stress relaxation was determined immediately following the end of the second cycle by performing an elongation to 50% (also at 500%/min), measuring the force at the end of this extension, holding the extension at 50% for 1 minute, and then determining the force remaining after this 1 minute. Stress relaxation (SR) is calculated via: SR=100%×(Force (initial, 50%)−Force (1 min, 50%))/(Force (initial, 50%)).

### Examples V0-V13 and 1-6

Samples of 50 gsm sheath/core (“S/C”) fibers of copolymer propylene-ethylene elastomer with a polyethylene sheath (ASPUN 6811A polyethylene) at 93%/7% w/w were prepared. These samples were biaxially stretched (simultaneously in both MD and CD) at 0, 100, 150, and 200% at 40 C on an Iwamoto stretcher. Two of the samples were subjected to ring rolling, one time in both directions, using a CD ring roller with 0.149″ engagement. Single samples were measured in both the MD and CD directions on an Instron device using a 2-cycle, 100% extension/recovery test. All reported values here have been normalized to a 3″ wide×50 gsm fabric. Set was determined from an expanded Y-axis view of the crossing of the baseline by the second cycle retraction curve. Stress relaxation, using 50% extension and a 1 minute hold, was determined from the raw tensile data to remove any machine compliance artifacts. The results are shown in Tables 1-4.

Microscopic, qualitative observations were made for all of the samples and gave the following general effects:
Biaxial stretching decreases the fiber diameter and fabric density.
Biaxial stretching causes the as-formed corrugations to be coarser (more space between ribs) and shallower (less depth of corrugation).
Incremental stretching (after biaxial stretching) restores fine (close) corrugation, but still shallower as compared to the as spun corrugations without stretch.
Incremental stretching may cause bond point breaks and fiber breaks at bond points (these samples may have been over-bonded). Incremental stretching damage is particularly severe as the % biaxial stretch goes up (and fabric becomes thinner).
Incremental stretching more than once can severely damaged the bond points.
Incremental stretching does not seem to reduce significantly the fiber diameter, but does reduce somewhat the fabric density, especially in the case of non-biaxially-stretched samples.

TABLE 1
Iwamoto Stretcher sample conditions and effects.

| | | Elongation | Fiber Diameter, |
|---|---|---|---|
| Name | Temp. C. | % | mu |
| V0 | 20 | 0 | 20 |
| V1 | 20 | 100 | 20 |
| V2 | 20 | 200 | 20 |
| V3 | 20 | 300 | 20 |
| V4 | 20 | 150 | 19 |
| V5 | 20 | 100 | 18 |
| V6 | 20 | 200 | 15 |
| V7 | 40 | 200 | 17 |
| V8 | 40 | 300 | 16.5 |
| V9 | 40 | 250 | 17 |
| V10 | 40 | 200 | 17 |
| V11 | 60 | 100 | 17 |
| V12 | 60 | 200 | 17 |
| V13 | 60 | 200 | 15 |

TABLE 2
Fabric tensile data for biaxially stretched samples.
Forces are normalized for fabrics 3″ wide & 50 gsm.

| | Base Wt. | | Ef(100) | Set | SR | Rf(50) | Rf(30) |
|---|---|---|---|---|---|---|---|
| Sample | gsm | Orient. | g | % | % | g | g |
| V0 | 49.4 | MD | 1305 | 24 | 21.4 | 124 | 15 |
| V0 | 47.8 | CD | 675 | 26 | 20.4 | 53 | 5 |
| V1 | 47.2 | MD | 1461 | 18 | 19.9 | 155 | 40 |
| V2 | 35 | CD | 580 | 14.5 | 19 | 70 | 21 |
| V3 | 34.6 | CD | 560 | 15 | 19.5 | 69 | 20 |
| V4 | 37.3 | MD | 1242 | 12 | 19.1 | 160 | 57 |
| V5 | 44 | CD | 560 | 19 | 19.3 | 55 | 12 |
| V6 | 35.3 | CD | 575 | 14 | 17.9 | 74 | 21 |
| V7 | 21.2 | MD | 3279 | 18 | 20.6 | 198 | 44 |
| V8 | 29.3 | CD | 1082 | 17 | 18.2 | 105 | 29 |
| V9 | 24.2 | CD | 1123 | 19 | 19.5 | 91 | 20 |
| V10 | 21.9 | MD | 2829 | 19 | 20.6 | 179 | 39 |
| V11 | 26.9 | MD | 1926 | 22 | 20.2 | 130 | 24 |
| V12 | 15.1 | MD | 2322 | 25 | 22.5 | 97 | 13 |
| V13 | 18.7 | CD | 1870 | 24 | 21.3 | 93 | 13 |

Abbreviations:
gsm = grams per cm²; Ef(100) = Extensional force at 100% elongation (second cycle); SR = stress relaxation; Rf(50 or 30) = retractive force at 50% or 30% elongation (second cycle); g = grams; Orient. = orientation of the sample for this 1-dimensional test, MD = machine direction sample; CD = Cross Direction sample.

TABLE 3
Biaxially stretched and incrementally stretched (IS) fabrics.

| | Basis | | | | | | |
|---|---|---|---|---|---|---|---|
| | Wt. | Ef(100) | Set | SR | Rf(50) | Rf(30) | Dia. |
| Sample | gsm | g | % | % | g | g | mu |
| 0/MD | 42.9 | 1346 | 21 | 20.3 | 139 | 24 | |
| 0/CD | 50.7 | 674 | 27 | 21.1 | 44 | 1 | |
| 0/MD* | 49.4 | 1305 | 24 | 21.4 | 124 | 15 | 20 |
| 0/CD* | 47.8 | 675 | 26 | 20.4 | 53 | 5 | |
| 0/IS/MD | 37.5 | 814 | 16 | 18.3 | 127 | 39 | 19 |
| 0/IS/CD | 39.2 | 428 | 17 | 18.3 | 51 | 12 | |
| 100/MD | 35.8 | 1563 | 21 | 21.3 | 123 | 17 | 18 |
| 100/CD | 38.7 | 920 | 21 | 21.1 | 66 | 7 | |
| 100/IS/MD | 32.8 | 852 | 19 | 19 | 115 | 25 | 17 |
| 100/IS/CD | 32.2 | 457 | 19 | 18.4 | 48 | 8 | |
| 150/MD | 29.6 | 1874 | 19 | 20.3 | 139 | 26 | 17 |
| 150/CD | 30.2 | 777 | 20 | 20 | 51 | 6 | |
| 150/2xIS/MD | 19 | 479 | 21 | 18.8 | 36 | 3 | 17 |
| 200/MD | 19.4 | 2745 | 21 | 20.6 | 148 | 24 | 15 |
| 200/CD | 22.2 | 1233 | 21 | 21.1 | 73 | 8 | |
| 200/IS/MD | 21.8 | 716 | 22 | 19.5 | 65 | 5 | 16 |
| 200/IS/CD | 18.5 | 357 | 23 | 18.1 | 27 | 4 | |

*Replicates of the controls (0 stretch) without the inventive biaxial stretching nor comparative incremental stretching. The incremental stretch (IS) was, in each case, 387% (stretch factor of 4.87).

Samples were also investigated at a single biaxial extension (100% in both MD and CD) as a function of temperature under stretch.

TABLE 4
Tensile data. Basis weight is determined
from the sample punch out.

| | Stretching | | | | | | |
|---|---|---|---|---|---|---|---|
| | Temperature, | Basis | Ef(100), | Set, | SR, | Rf(50), | Rf(30), |
| ID | C. | Wt. | g | % | % | g | g |
| Control | 20 | 45.5 | 1410 | 22 | 19.9 | 153 | 29 |
| V1 | 20 | 47.2 | 1461 | 18 | 19.9 | 155 | 40 |
| 1 | 40 | 38.6 | 1514 | 19.5 | 21.1 | 133 | 24 |
| 2 | 45 | 33.4 | 1610 | 21 | 21.0 | 122 | 21 |
| 3 | 50 | 32.6 | 1677 | 22 | 21.2 | 122 | 16 |
| 4 | 55 | 29.7 | 1673 | 22 | 21.6 | 111 | 13 |
| 5 | 60 | 27.8 | 1724 | 23 | 21.6 | 114 | 14 |
| 6 | 70 | 26.9 | 2035 | 24.5 | 22.6 | 109 | 9 |

### Example: 7-16

### Stretching in Either the MD or CD on a Production-Ready Differential Drive and Tenter Frame Apparatus

The examples below were produced on r a 2.5 meter production line and subsequently stretched either in the MD or CD direction, on a Differential Drive system (for MD stretch) or a Tenter Frame (for CD stretch).

Description of the Differential Drive System

The system is a series of rollers and drives capable of taking a 2.5 meter wide web and moving it at different rates throughout the system to achieve either stretch (increasing velocity) or relaxation (decreasing velocity). The system has 3 drive regions, each with multiple rolls and drives to control the set velocity of the web and avoid slippage. There is no means for maintaining the cross direction width, which may, and probably will, decrease during MD stretch. The drive units and rolls are heatable.

Description of the Tenter Frame

The tenter frame is a set up in multiple regions for temperature control and stretching versatility. Basically there is an initial region used to preheat the sample with little or no stretching, followed by a region that is used to stretch the sample under heating, a hold region to further allow equilibration of the ultimate stretch to temperature, and a final relaxation region where the web may be reduced in width at either a higher or lower temperature. The entire process occurs at nearly a constant MD velocity, so the MD orientation is not allowed to relax appreciably during CD extension.

### Example 7

A 50 gsm fabric was made from a 93/7 Core/sheath bicomponent elastic fiber based on PELLETHANE 2102 75A elastomeric polyurethane as the core elastomer and a fiber-grade polyethylene sheath and the thermopoint bonded web was fed directly into the CD tenter frame. Equilibration temperature at the beginning was set to 80-90 C. Stretching and relaxation steps were done at a temperature of 95 and 100 C, respectively. The web was initially 1.8 meters and ultimately 4.4 meters wide. The basis weight at the end was 25 gsm. The linear density of the fibers for the original material was 3.9 dtex (grams/10,000 meters or ˜22 micron diameter fibers on average) and the CD tentered material had a reduced density of 2.14 dtex (˜16.5 micron diameter).

### Examples 8-14

An off-line CD only stretching experiment was performed to investigate the impact of temperature and stretch in the various regions within the tenter frame. The elastic nonwoven used was produced on the Production line days prior to the stretch trial. The material was a 90/10 Core/Sheath bicomponent fiber based spunbond, using PELLETHANE 2102 75A elastomeric polyurethane as the core and fiber-grade polyethylene as the sheath. The basis weight was 50 gsm and the initial width was between 2 and 2.1 meters. Table 5 describes the temperature and stretch profiles used for the samples. Table 6 presents some of the measured tensile values obtained (as described above) for the initial web and the stretched webs.

TABLE 5
Stretch and temperature settings for CD tentering examples

| | Initial | Final | | Initial | Final |
|---|---|---|---|---|---|
| | Width, | Width, | Stretch | Temperature, | Temperature, |
| Sample | m | m | Factor | C. | C. |
| Control | 2.4 | 2.4 | 1 | — | — |
| Ex. 8 | 2.0 | 3.5 | 1.75 | 80 | 80 |
| Ex 9 | 2.1 | 3.9 | 1.86 | 100 | 100 |
| Ex 10 | 2.1 | 4.3 | 2.05 | 120 | 120 |
| Ex 11 | 2.1 | 5.0 | 2.38 | 120 | 120 |
| Ex 12 | 2.1 | 3.2 | 1.52* | 120 | 140 |
| Ex 13 | 2.1 | 3.1 | 1.48** | 120 | 140 |
| Ex 14 | 2.1 | 3.1 | 1.48 | 120 | 120 |

*Let down from a maximum extension of 2.0.
**Let down from a maximum extension of 1.81.
Note:
A 1.5 times Stretch Factor is equivalent to a 50% elongation.

TABLE 6
Data for CD tentered Examples 8-14

| | Basis | | | | | |
|---|---|---|---|---|---|---|
| | Wt., | MD | CD | CD/MD | CD Set, | CD SR, |
| Sample | gsm | Rf(50), g | Rf(50), g | Rf Ratio | % | % |
| Control | 52.7 | 123 | 39 | 0.32 | 30.3 | 25.6 |
| Ex. 8 | 42.5 | 93 | 41 | 0.44 | 25.7 | 26.1 |
| Ex 9 | 34.9 | 61 | 33 | 0.54 | 26.1 | 27.3 |
| Ex 10 | 28.7 | 42.5 | 26 | 0.61 | 28 | 28 |
| Ex 11 | 26.6 | 33 | 25 | 0.76 | 27.6 | 28.7 |
| Ex 12 | 29.7 | 65 | 38 | 0.58 | 33.1 | 26.3 |
| Ex 13 | 31.1 | 66 | 39 | 0.59 | 33.2 | 26.2 |
| Ex 14 | 35.3 | 56 | 32 | 0.57 | 29.1 | 28 |

From the data in Table 6 it is clear that the inventive CD tenter stretching is effective at reducing the basis weight of the starting elastic nonwoven. The basis weight is reduced most strongly by an increasing stretch ratio but also by an increasing temperature. At temperatures >120 C (optimal bond temperature for this fabric) the set suffers, while at and especially below the bond temperature the set is improved. The ratio of the Rf(50)'s (stretched orientation or CD divided by the unstretched orientation or MD) shows a similar increase with decreasing basis weight or increasing stretch factor. In some applications a balance in tensile performance is desired for the two orientations (ratio of 1). Thus, application of this invention can be used to improve this balance.

### MD Differential Stretch

### Examples 15 and 16

Examples 15 and 16 were stretched in only the MD direction on the Differential stretch system. Example 15 was produced from a 120 gsm, 95/5 Core/Sheath bicomponent fiber based spunbond, made from PELLETHANE 2102 75A elastomeric polyurethane as the elastic core and ASPUN 6811A polyethylene as the sheath (both materials sold by The Dow Chemical Co.). Example 15 was stretched at a temperature of 60 C with a profile of 1.5/1.0/1.5, for an overall stretch ratio of 2.25 (1.5×1.0×1.5). Example 16 was produced from a ˜40 gsm, 97/3 Core/Sheath bicomponent fiber based spunbond, made from PELLETHANE 2102 75A elastomeric polyurethane as the elastic core and spunbond grade polypropylene as the sheath. Example 16 was stretched with a profile of 1.3/1.0/1.1, for an overall stretch ratio of 1.43. Table 7 presents the properties for these inventive stretched samples and their corresponding controls. As described above, these Examples did not have their widths fixed and thus the width was reduced to accommodate most of the MD stretch (no decrease in basis weight observed).

TABLE 7
MD only stretch inventive Examples.

| | Basis | | | | | |
|---|---|---|---|---|---|---|
| | Wt., | MD | CD | MD/CD | MD Set, | MD SR, |
| Sample | gsm | Rf(50), g | Rf(50), g | RF Ratio | % | % |
| Control | 120 | 397 | 220 | 1.80 | 19 | 18 |
| 15 | | | | | | |
| Control | 37 | 88 | 25 | 3.52 | 14 | 19 |
| 16 | | | | | | |
| Ex 15 | 120 | 466 | 132 | 3.53 | 16 | 18 |
| Ex 16 | 41.6 | 117 | 19 | 6.16 | 10 | 17 |

The data presented in Table 7 show that the tensile properties of the stretched orientation are improved relative to the orthogonal orientation (the MD/CD ratio in this case of MD stretch), in both of these cases by almost 100%. Some applications can benefit from large differences in tensile properties, such as previous commercial materials utilizing only 1-D elasticity in their construction. These materials might be like these, but with some elasticity in both directions. It is also seen from the Table that MD stretch is good for lowering (improving) the Set (not shown is the fact that the CD set is also lowered).

What is claimed is:

1. A method for producing an elastic nonwoven fabric, comprising:
stretching a nonwoven web in the cross machine direction, machine direction, or both to reduce the basis weight, denier, or both of the nonwoven web to form the elastic nonwoven fabric,
wherein the nonwoven web comprises a plurality of multicomponent strands having first and second polymer components longitudinally coextensive along the length of the strands, said first component comprising an elastomeric polymer, and said second polymer component comprising a polymer less elastic than the first polymer component.

2. The method according to claim 1 wherein the web is stretched in the cross and machine directions simultaneously.

3. The method according to claim 1, wherein the web is stretched in the cross direction using a tenter frame, is stretched in the machine direction using differential roller speeds, or both.

4. The method according to claim 1, wherein the nonwoven web is formed by:
melt spinning a plurality of multicomponent strands having first and second polymer components longitudinally coextensive along the length of the strands, said first component comprising an elastomeric polymer, and said second polymer component comprising a non-elastomeric polymer;
forming the multicomponent strands into a nonwoven web; and
bonding or intertwining the strands to form a coherent bonded nonwoven web.

5. The method of claim 4, wherein the nonwoven web is produced via spunbonding.

6. The method of claim 1, wherein the stretching occurs to at least 50% elongation in at least one direction to achieve at least a 20% reduction in basis weight.

7. The method of claim 1, wherein the stretching occurs to at least 50% elongation in only one direction to achieve at least a 20% increase in the ratio of the retractive forces at 50% extension (Rf(50)) for the stretched orientation over the orthogonal orientation, relative to the same ratio in the unstretched web.

8. The method of claim 1, wherein the nonwoven web has been thermo point bonded prior to stretching.

9. The method of claim 1, wherein the process occurs in the absence of an incremental stretching step.

10. The method according to claim 8, wherein the stretching occurs at a web temperature between 20 degrees Centigrade and the thermopoint bonding temperature of the spunbonded web.

11. The method according to claim 4, wherein the first polymer component comprises an elastomeric polyurethane, elastomeric polyethylene copolymers, elastomeric polypropylene copolymers, elastomeric styrenic block polymers, or blends thereof, and the second polymer component comprises a polyolefin that is less elastic than the elastomeric polymer.

12. The method according to claim 11 wherein the second polymer component is polypropylene, polyethylene, or a blend thereof.

13. The method according to claim 4, wherein the melt spinning comprises arranging the first and second polymer components in the strand cross-section to form a sheath/core configuration.

14. The method according to claim 4, wherein the melt spinning comprises arranging the first and second polymer components in the strand cross-section to form polymer components in a tipped multilobal configuration.

15. The method according to claim 1, wherein at least a portion of the multicomponent strands has a sheath/core configuration.

16. A nonwoven fabric made by the method of any of the preceding claims.

17. A multilayer composite, comprising at least one layer formed by the method of claim 1.

18. An article produced at least in part with a material prepared according to claim 1.
